(19) United States
(12) Patent Application Publication
(10) Pub. No.: US 2008/0059439 A1
(43) Pub. Date: Mar. 6, 2008

(54) Query Translation from XPath to SQL in the Presence of Recursive DTDs

(75) Inventors: Wenfei Fan, Somerset, NJ (US); Rajeev Rastogi, New Providence, NJ (US)

Correspondence Address: SYNNESTVEDT & LECHNER LLP;LUCENT TECHNOLOGIES INC., 1101 MARKET STREET, SUITE 2600, PHILADELPHIA, PA, 19107, US

(73) Assignee: LUCENT TECHNOLOGIES INC., Murray Hill, NJ (US)

(21) Appl. No.: 11/468,533

(22) Filed: Aug. 30, 2006

(51) Int. Cl. G06F 17/30

(52) U.S. Cl. 707/4

(57) ABSTRACT

The invention provides a system and method for translating XPATH queries into SQL queries with a simple least fixpoint (LFP) operator, which is already supported by most commercial RDBMS. The method comprises the steps of (a) rewriting an input query into a regular query, which is capable of capturing both DTD recursion and XPATH queries in a uniform framework; and (b) translating the regular query to an SQL query with LFP. The invention further provides optimization techniques for reducing the use of the LFP operator. As a result, the invention is capable of answering a large class of XPATH queries by means of only low-end RDBMS features already available in most RDBMS.

### 1 COPYRIGHT NOTICE

This patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2 FIELD OF THE INVENTION

The present invention relates to methods and interfaces for evaluating XML queries by relational database systems and, more particularly, for translating XPath queries to relational SQL queries in the presence of possibly recursive DTDs.

### 3 DESCRIPTION OF THE RELATED ART

It is increasingly common to find XML data stored in a relational database management system (“RDBMS”), typically based on “DTD”/schema-based shredding into relations as found in many commercial products. With this comes the need for answering XML queries using an RDBMS, by translating XML queries to SQL. (In SGML and XML, a Document Type Definition (“DTD”) is a document or portion of a document expressing a schema via a set of declarations that conform to a particular markup syntax and that describe a class, or type, of documents (e.g., SGML or XML documents), in terms of constraints on the structure of those documents.)

The query translation problem can be stated as follows. Consider a mapping τ_{d}, defined in terms of DTD-based shredding, from XML documents conforming to a DTD, D, to relations of a schema R. Given an XML query, Q, it is desirous to identify a sequence of equivalent SQL queries, Q′, such that for any XML document, T, conforming to the DTD, D, the XML query, Q, run on the XML document, T, can be answered by evaluating the sequence, Q′, on the database τ_{d}(T) of R that represents the XML document T. In other words, the set of nodes (ids) selected by Q on T equals the set of (unary) tuples (encoding T nodes) selected by Q′ on τ_{d}(T) (hereinafter denoted by Q(T)=Q′(τ_{d}(T))). One assumes further that DTDS D may be recursive, and that queries Q are written in XPATH, which is essential for XML query languages XQuery and XSLT.

The query translation problem is, however, nontrivial, because DTDS or XML schema found in practice are often themselves recursive and complex. This is particularly evident in databases describing real-life applications, such as biopolymer sequencing (e.g., using the BIOpolymer Markup Language, or BIOML, which contains a number of nested and overlapping cycles when represented as a graph). Unfortunately, the interaction between recursion in a DTD and recursion in an XML query complicates the translation of the query.

Several approaches to the translation problem have been proposed. In a first proposed solution, used when the DTD has a structure resembling a tree or a directed acyclic graph (“DAG”) (i.e., a directed graph with no directed cycles), one enumerates all matching paths of the input XPATH query in a DTD, sharing common sub-paths, rewrites the paths into SQL queries, and takes a union of these queries. However, this approach does not work for recursive DTDS, since it may lead to infinitely many paths in the presence of the descendants-or-self axis specifier “//” in the XPATH query.

Another approach uses an intermediate language and middleware: first express input XML queries in the intermediate language, and then evaluate the translated queries leveraging the computing power of the middleware and the underlying RDBMS. A system implementing this approach, based on middleware and XML views, provides clients with an XML view of the relations representing the XML data. Upon receiving an XML query against the view, the system composes the query with the view, rewrites the composed query to a query in a (rich) intermediate language, and answers the query by using both the middleware and the underlying RDBMS. However, this approach poses several difficulties. First, it is nontrivial to define a (recursive) XML view of the relational data without loss of the original information. Second, it requires implementation of the middleware on top of the RDBMS and incurs communication overhead between the middleware and the RDBMS. Third, at the time of the invention, few, if any, algorithms had been developed for handling recursive queries over XML views with a recursive DTD.

Still another approach, the XPATH queries are translated to SQL extended with a recursion operator, and the work required to evaluate the SQL queries is pushed to the underlying RDBMS. This approach capitalizes on the capabilities of the RDBMS to evaluate and optimize the queries. Although much research has been done on storing and querying XML using an RDBMS, the problem of translating recursive XML queries into SQL in the presence of recursive DTDS has not been solved.

In yet another recent approach to the query translation problem, the path queries are translated into the SQL'99 query language, which is capable of translating queries with // and limited qualifiers to a sequence of SQL queries with the linear-recursion construct with . . . recursive. Unfortunately, this approach also has several limitations. The first weakness is that it relies on the SQL×99 recursion functionality, which is not currently supported by many commercial products, including Oracle and Microsoft SQL Server. It would be beneficial to have an effective query translation approach that works with a wide variety of products supporting low-end recursion functionality, rather than requiring an advanced RDBMS feature of only the most sophisticated systems. Second, the SQL queries with the SQL×99 recursion produced by existing translation algorithms are typically large and complex, with excessive and unnecessary use of unions and joins. As a result, they may not be effectively optimized by all platforms supporting SQL'99 recursion, for the same reasons that not all RDBMS platforms can effectively optimize mildly complex non-recursive queries. A third problem is that path queries handled by existing algorithms are too restricted to express XPATH queries commonly found in practice.

### 4 BRIEF SUMMARY OF THE INVENTION

The present invention provides a novel system and method for translating a class of XPATH queries to SQL, based on regular queries and a simple least fixpoint (LFP) operator. A regular query, as used herein, is a query having regular expressions and supporting the general Kleene closure E*. A regular query written in the XPATH language is known as a regular XPATH query. The LFP operator Φ(R) takes a single input relation R instead of multiple relations, as in the SQL'99 with . . . recursion operator. Moreover, the LFP operator Φ(R) is already supported by many commercial systems such as Oracle (connectby) and IBM DB2 (with . . . recursion), and is expected to be supported by Microsoft SQL Server 2005.

Advantageously, regular XPATH queries are capable of expressing a large class of XPATH queries over a recursive DTD D. That is, regular XPATH queries capture both DTD recursion and XPATH recursion in a uniform framework. Further, each regular XPATH query can be rewritten to a sequence of equivalent SQL queries with the LFP operator.

Thus, the translation method in accordance with the invention comprises the following steps: (a) rewriting an query Q into a regular query E_{Q}, and then translating the regular query E_{Q} to an equivalent sequence Q′ of SQL queries. Both E_{Q} and Q′ are bounded by a low polynomial in the size of the input query Q and the DTD D. The invention further provides an efficient algorithm for translating an input query over a recursive DTD D to an equivalent regular query, and an algorithm for rewriting a regular query into a sequence of SQL queries with the LFP operator. Preferably, the translation further includes optimization techniques to minimize the use of the LFP operator and to push selections into LFP in the rewritten SQL queries.

The translation method in accordance with the invention has numerous advantages over the existing approaches. First, it requires only low-end RDBMS features instead of the advanced SQL'99 recursion functionality. As a result, it provides a variety of commercial RDBMS with an immediate capability to answer XPATH queries over recursive DTDS. Second, it produces SQL queries that are less complex than their counterparts generated with the SQL'99 recursion, and can be optimized by RDBMS platforms by known techniques for multi- and recursive SQL query optimization. Finally, it is capable of handling a class of XPATH queries supporting child, descendants and union as well as rich qualifiers with data values, conjunction, disjunction and negation.

These and other features of the invention will be more fully understood by references to the following drawings.

### 5 BRIEF DESCRIPTION OF THE DRAWINGS

FIG. 1(a) is a graph representation of a representative DTD.

FIG. 1(b) is a simplified representation of FIG. 1(a).

FIG. 2 is a graphical representation of a translation method in accordance with the invention.

FIGS. 3(a) through 3(c) are exemplary DTD graphs with three, four, and two simple cycles, respectively.

FIG. 4(a) is an exemplary DTD graph depicting two cross cycles.

FIG. 4(b) is a four-cycle DTD graph extracted from BIOML.

FIGS. 5(a) through 5(h) are graphs depicting the processing time for cross cycles using a translation algorithm in accordance with the invention.

FIGS. 6(a) and 6(b) are graphs comparing the translation algorithm in accordance with the invention with existing algorithms.

FIGS. 7(a) through 7(d) are graphs depicting various DTD graphs extracted from BIOML.

FIG. 8 is a graph comparing the performance of the translation algorithm in accordance with the invention with existing algorithms, based on DTDS depicted in FIG. 7(a) through 7(d).

### 6 DETAILED DESCRIPTION OF THE INVENTION

### 6.1 DTD, XPath, Schema-Based Shredding

The present invention arises in the context of DTDS, XPATH queries, and DTD-based shredding of XML data into relations. As such, a review of these concepts is provided below. Familiarity with standard relational algebraic notation is assumed.

### 6.1.1 DTDs

A DTD D may be represented as (Ele, Rg, r), where Ele is a set of element types; r is a root type; and Rg defines the types: for any type A in Ele, Rg(A) is a regular expression:

α::=ε|B|α,α|(α|α)|α*,

where ε is the empty word or null set, B is a type in Ele (referred to as a subelement or child type of A), and ‘|’, ‘,’ and ‘*’ denote disjunction, concatenation and the Kleene star, respectively. The A→Rg(A) may be referred to as the production of A. For simplicity, attributes need not be considered here, and it is assumed that an element v may possibly carry a text value (PCDATA) denoted by value v.val. An XML document that conforms to a DTD is called an XML tree of the DTD.

A DTD D may be represented as a graph, called the DTD graph of D and denoted by graph G_{D}. In graph G_{D}, each node represents a distinct element type A in D, called the A node, and an edge denotes the parent/child relationship. Specifically, for any production A→α, there is an edge from the A node to the B node for each subelement type B in α. The edge is labeled with ‘*’ if B is enclosed in α₀* for some sub-expression α₀ of α. When it is clear from the context, DTD and its graph are used interchangeably below.

A DTD is recursive if its DTD graph is cyclic (i.e., has an element type that is defined (directly or indirectly) in terms of itself). A DTD graph G_{D} is called a n-cycle graph if G_{D} contains n simple cycles in which no node appears more than once.

### EXAMPLE 6.1

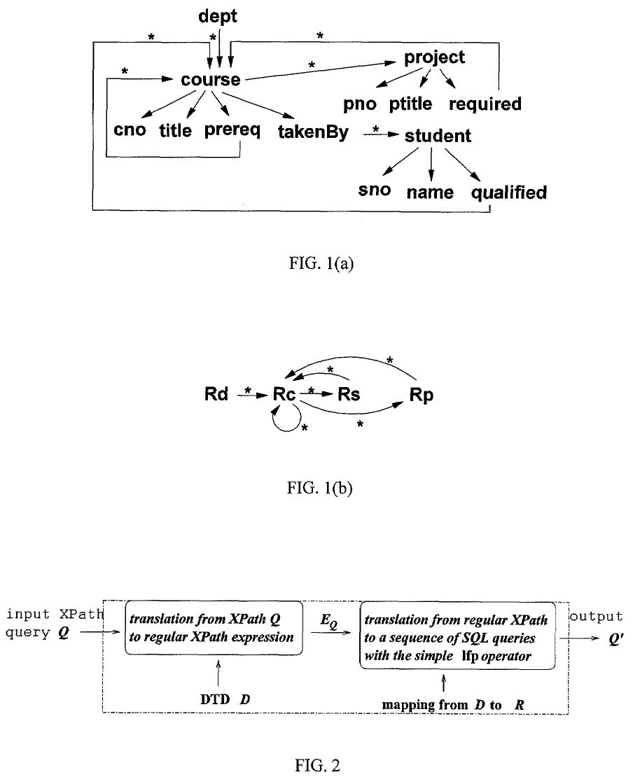

A dept DTD is depicted in FIG. 1(a), which is a 3-cycle graph. As shown in FIG. 1(a), the dept has a list of course elements. Each course consists of a cno (course code), a title, a prerequisite hierarchy (via prereq), and all the students who have registered for the course (via takenBy). Each student has a sno (student number), a name and a list of qualified courses. A course may have several projects. Each project has a pno (project number), a ptitle (title) and required knowledge of other courses (required). □

### 6.1.2 XPath Queries

Consider a fragment of an XPATH query that supports recursion (descendants) and rich qualifiers, given as follows:

p::=ε|A|*|p/p|p//p|p∪p|p[q]

q::=p|text( )=c| [symbol] q|q [symbol] q|q [symbol] q

where ε, A and * denote the self-axis, a label and a wildcard, respectively; ‘∪’, ‘/’ and ‘//’ are union, child-axis and descendants-or-self-axis, respectively; and q is called a qualifier, in which c is a constant, and p is the XPATH sub-query as defined by the above equation.

The XPATH sub-query p, when evaluated at a context node v in an XML tree T, returns the set of nodes of T reachable via p from v, denoted by v [[p]]. The operator is used here to denote a special query, which returns the empty set over all XML trees, with ∪p equivalent to p and p//p′ equivalent to . To simplify the discussion below it is assumed that qualifiers [text( )=c] and [ [symbol] q] only appear in the form of p[text( )=c] and p[ [symbol] q] where p is an XPATH sub-query that is not ε.

This class of XPATH queries properly contains known branching path queries and tree patterns. This class of queries will be referred to herein simply as XPATH queries.

### EXAMPLE 6.2

Consider Two XPATH Queries.
Q₁=dept//project
Q₂=dept/course[ε//prereq/course/cno=“cs66” [symbol] [symbol] ε//project [symbol] [symbol] takenBy/student/qualified//course/cno=“cs66”]

### On an XML tree of the dept DTD of FIGS. 1a and 1b, the first query is to find all projects, and the

TABLE 1
A database encoding an XML tree of the dept DTD

| | |
|---|---|
| F | T |

(a) R_{d}

| | |
|---|---|
| — | d₁ |

(b) R_{c}

| | |
|---|---|
| d₁ | c₁ |
| c₁ | c₂ |
| c₂ | c₃ |
| p₁ | c₄ |
| s₂ | c₅ |

(c) Rₛ

| | |
|---|---|
| c₁ | s₁ |
| c₁ | s₂ |

(d) Rₚ

| | |
|---|---|
| c₂ | p₁ |
| c₄ | p₂ |

second one is to find courses that (1) have a prerequisite cs66, (2) have no project related to them or to their prerequisites, but (3) also have a student who registered for the course but did not take cs66. □

### 6.1.3 Mapping DTDs into a Database Schema

The present invention focuses on DTD-based shredding of XML data into relations, e.g., via known shared-inlining techniques as supported by most commercially available RDBMS. A DTD-based shredding is a mapping τ_{d}: D→R from XML trees of DTD D to databases of relational schema R.

To simplify the discussion it may be assumed that τ_{d} maps each element of type A to a relation R_{A} in R, which has three columns F (from, i.e., parentId), T (to, i.e., ID) and V (value of all other attributes). Intuitively, in a database τ_{d}(Tᵣ) representing an XML tree Tᵣ, each R_{A} tuple (f, t, v) represents an edge in Tᵣ from a node f to an A-element t which may have a text value v, where t and f are denoted by the node IDs in Tᵣ and are thus unique in the database, and v is ‘_’ in the absence of text value at t. In particular, f=‘_’ if f is the root of Tᵣ. This assumption, however, does not cause the method to lose generality—the query translation techniques of the present invention may readily be extended to handle mappings without this restriction.

### EXAMPLE 6.3

With the shared-inlining technique, the DTD of FIG. 1(a) is mapped to a schema with four relation schemas, R_{d}, Rₑ, Rₚ and Rₛ, representing dept, course, project and student, respectively (see FIG. 1(b) for the simplified representation of FIG. 1(a)). A sample database is given in Table 1, which only shows F and T columns.

### 6.2 Overview: From XPath to SQL

The query translation problem from XPATH to SQL may be stated mathematically as follows: For a mapping τ_{d}: D→R from XML trees of DTD D to databases of relational schema R, it is to find an algorithm that, given an XPATH query Q, effectively computes an equivalent sequence of relational queries Q′ such that for any XML tree T of the DTD D, Q(T)=Q′(τ_{d}(T)).

This section reviews the approach proposed by Krishnamurthy et al. in a paper entitled “Recursive XML Schemas, Recursive XML Queries, and Relational Storage: XML-to-SQL Query Translation” published in ICDE 2004—the only existing solution for the query translation problem in the presence of recursive DTDS. The new approach in accordance with the present invention is then described in the next two sections.

### 6.2.1 Linear Recursion of SQL'99

The algorithm of Krishnamurthy et al., referred to as SQLGen-R, handles recursive path queries over recursive DTDS based on SQL'99 recursion. Given an input path query, SQLGen-R first derives a query graph, G_{Q}, from the DTD graph to represent all matching paths of the query in the DTD graph. It then partitions G_{Q} into strongly-connected components c₁, . . . , cₙ, sorted in the top-down topological order. It generates an SQL query Qᵢ for each cᵢ, and associates Qᵢ with a temporary relation TRᵢ such that TRᵢ can be directly used in later queries Qⱼ for j>i. The sequence TR₁←Q₁ . . . ; TRₙ←Qₙ is the output of the algorithmn.

If a component cᵢ is cyclic, the SQL query Qᵢ is defined in terms of the with . . . recursive operator. More specifically, it generates an initialization part and a recursive part from cᵢ. The initialization part captures all “incoming edges” into cᵢ. The recursion part first creates an SQL query for each edge in component cᵢ, and then encloses the union of all these (edge) queries in a with . . . recursive expression. Note that if component cᵢ has k edges, Qᵢ actually calls for a fixpoint operator φ(R, R₁, R₂, . . . Rₖ) with k+1 input relations, defined as follows:

R⁰←R

Rⁱ←Rⁱ⁻¹∪(Rⁱ⁻¹ [symbol] _{c}_{ᵢ} R₁)∪ . . . ∪(Rⁱ⁻¹ [symbol] _{c}_{ₖ} Rₖ) (1)

where R⁰ corresponds to the initialization part, Rⱼ corresponds to an SQL query coding an edge in component cᵢ, and Cⱼ is a Boolean expression on join, for each jε[1, k].

TABLE 2
The SQL statement generated by SQLGen-R

| 1. | with | |
|---|---|---|
| 2. | R (F, T, Rid) as ( | |
| 3. | (select R.F, R_{c}.T, Rid(’c’) | |
| 4. | from R, R_{c} where R.T = R_{c}.F and Rid = ’c’) | |
| 5. | union all | /* followed by 5 more similar select queries |
| | | and 4 more union all operations */ |

### EXAMPLE 6.4

Recall the mapping from the dept DTD to the relational schema R consisting of Rₛ, R_{c}, Rₚ, R_{d} given in Example 6.3, and the XPATH query Q₁=dept//project given in Example 6.2, which, over the DTD graph of FIG. 1(b), indicates R_{d}//Rₚ. Given Q₁ and the DTD graph of FIG. 1(b), the algorithm SQLGen-R finds a strongly-connected component (R_{c}//Rₚ) having 3 nodes and 5 edges, and produces a single SQL query using a with . . . recursive expression, as shown in Table 2. □

Observe the following about the query of Table 2. First, it actually requires a fixpoint operator that takes 4 relations as input. As remarked in Section 3, the functionality of φ(R, R₁, R₂, . . . Rₖ) is a high-end feature that few RDBMS support. Second, it is a complex query, in that each iteration of the fixpoint must compute five joins and five unions. Third, all five relations join the result relation R in the center, which forms a star shape and is hard to optimize.

### 6.2.2 The Present Invention

To this end, the present invention provides a new approach to translating XPATH queries to SQL, based on extended XPATH expressions and the simple LFP operator Φ(R).

Regular XPATH expressions. A regular XPATH expression E over a DTD D is syntactically defined as follows:

E::=ε|A|E/E|E∪E|E*|E[q],

q::=E|text( )=c| [symbol] q|qιq|q←q.

where A is an element type in D. The semantics of evaluating a regular XPATH expression E over an

TABLE 3
An implementation of LFP in Oracle and DB2

```
LFP Φ (R) in Oracle
    select F, T from R connect by F = prior T
LFP Φ (R) in DB2
    1. with
    2. R_{Φ} (F, T) as (
    3. (select F, T from R)
    4. union all
    5. (select R_{Φ}.F, R.T from R_{Φ}, R where R_{Φ}.T = R.F)
```

### XML tree is similar to its XPATH counterpart.

Regular XPATH differs from XPATH, in that it supports general Kleene closure E* as opposed to restricted recursion ‘//’ (descendents-or-self axis specifier). The motivation for using the general Kleene closure E* instead of the ‘//’ descendents-or-self axis specifier is that with the general Kleene closure E* one can define a finite representation of possibly infinite matching paths of an XPATH query over a recursive DTD.

In short, the regular XPATH expression E takes a union of all matching simple cycles of the // descendents-or-self axis and then the E* applies the Kleene closure to the union; each of these paths can then be directly mapped to a sequence of relations connected by joins. These joined relations may then be further optimized, as described below.

The simple LFP operator. The LFP operator Φ(R) takes a single input relation R, as shown below.

R⁰←R

Rⁱ←Rⁱ⁻¹∪(Rⁱ⁻¹ [symbol] _{c}R⁰) (2)

where C is a Boolean expression on the join. The LFP operator is already supported by most commercial RDBMS products. For example, Table 3 shows an implementation of the LFP operator Φ(R) in Oracle and IBM DB2 when C is simply R_{Φ}.T=R.F, where R_{Φ} is the relation being computed by Φ(R).

To illustrate how the LFP operator Φ(R) handles Kleene closure, consider a regular XPATH query (A₂/ . . . /Aₙ/A₁)* representing a simple cycle A₁→ . . . →Aₙ→A₁, where the source and destination are A₁ and Aₙ, respectively. This query can be rewritten into the LFP operation Φ(R) (Eq. (2)) by letting

R←Π_{R}_{_{2.}}_{F,R}_{_{1.}}_{T}(R₂ [symbol] R₃ [symbol] . . . [symbol] Rₙ [symbol] R₁) (3)

Here, the projected attributes are taken from the attributes F (from) and T (to) in relations R₂ and R₁, respectively. The join between Rᵢ/Rⱼ is expressed as Rᵢ [symbol] _{R}_{_{i.}}_{T=R}_{_{j.}}_{F} Rⱼ, i.e., it returns Rᵢ tuples that connect to Rⱼ tuples. In general, the Kleene closure E* may be re-written to the LFP operation Φ(R), where R is a temporary relation associated with a query coding E.

In contrast to the LFP operation Φ(R) which takes a single input relation R, the linear-recursion operator φ (Eq. (1)) can take an unbounded number k of relations. One might be tempted to think that Eq. (1) can be coded with Eq. (2), as follows:

R⁰←R

Rⁱ←Rⁱ⁻¹∪(Rⁱ⁻¹ [symbol] R′)

where R′=∪ⱼ₌₁^{k}Rⱼ. But this is incorrect, because different conditions are associated with different joins in Eq. (1).

### A New Approach for Query Translation.

Based on the LFP operator Φ(R) and regular XPATH, the present invention provides a new framework for translating XPATH to SQL. As depicted in FIG. 2, in accordance with the invention, an input XPATH query Q is translated to an SQL query in two steps: (a) converting the XPATH query Q over a DTD D (which may be recursive) to an equivalent regular XPATH query E_{Q} over the DTD D; and (b) mapping the equivalent regular XPATH query E_{Q} into an equivalent sequence of SQL queries Q′ based on a mapping τ: D→Z, using the LFP operator to handle Kleene closure.

Suitable translation algorithms are provided below in Sections 6.3 and 6.4. These algorithms produce the equivalent regular XPATH query E_{Q} and the equivalent sequence of SQL queries Q′ bounded by a low polynomial in the size |Q| of the XPATH query Q and the size |D| of the DTD D.

### EXAMPLE 6.5

Consider again evaluating the XPATH query Q₁=dept//project over the dept DTD of FIGS. 1(a) and 1(b), in the same setting as in Example 6.4. The algorithms of the present invention first translate input XPATH query Q₁ to a regular XPATH query E_{Q}_{₁}=R_{d}/R_{c}/E*/Rₚ, where E=(R_{c}∪Rₛ/R_{c}∪Rₚ/R_{c}); and then rewrite the regular XPATH query E_{Q}_{₁} to a sequence of SQL queries (written in relational algebra), yielding the following output:

R_{cc}←R_{c}

R_{csc}←Π_{R}_{ₛ}_{.F,R}_{_{c}}_{.T}(Rₛ [symbol] _{R}_{ₛ}_{.T=R}_{_{c}}_{.F}R_{c})

Π_{R}_{ₚ}_{.F,R}_{_{c}}_{.T}(Rₚ [symbol] _{R}_{ₚ}_{.T=R}_{_{c}}_{.F}R_{c})

R_{cc}∪R_{csc}∪R_{cpc}

Φ(R)∪Π_{T,T}(R_{c})

Π_{R}_{_{d}}_{.T,R}_{ₚ}_{.T}(R_{d} [symbol] _{R}_{_{d}}_{.T=R}_{_{c}}_{.F}R_{c} [symbol] _{R}_{_{c}}_{.T=R}_{_{γ}}_{.F}R_{γ} [symbol] _{R}_{_{γ}}_{,T=R}_{ₚ}_{.F}Rₚ)

Contrast Example 6.5 with the SQL query of Table 2. While the outputted SQL queries in the above example include 3 unions and 5 joins in total, they are evaluated once only, instead of once in each iteration of the least fixpoint computation LFP of Table 2. Thus, the method of the present invention results in pulling the join and/or union out from the iteration and thereby reduces the evaluation cost.

### 6.3 From XPath to Regular XPath

This section describes an embodiment of the first step of the invention—rewriting an XPATH query Q over a recursive DTD D to an equivalent regular XPATH query E_{Q} over the DTD D. In a preferred embodiment, for any XML tree T of DTD D, the XPATH query Q(T) is equal to the rewritten equivalent regular XPATH query E_{Q}(T). An optimization technique that may be incorporated into the algorithm to reduce the number of Kleene closures in E_{Q} also is provided below.

### 6.3.1 Translation Algorithm

The algorithm, XPathToReg, exemplifying the first step described above of the method in accordance with the present invention, is based on dynamic programming. For each XPATH sub-query p of the input XPATH query Q and each type A in an input DTD D, the algorithm computes a translated regular sub-query (a.k.a. a “local translation”) Eₚ=x2r(p, A) from each sub-query p to a corresponding translated regular sub-query Eₚ. The sub-query p and the resulting translated regular sub-query Eₚ are preferably equivalent, when being evaluated at each A element. The algorithm then composes the translated regular sub-queries to produce the rewritten equivalent regular XPATH query E_{Q}=x2r(Q, r) from input query Q to E_{Q}, where r is the root type of DTD D.

In computing each local translation x2r(p, A), the algorithm evaluates sub-query p over the sub-graph of the DTD graph G_{D} rooted at A. In particular, the algorithm substitutes regular expressions over element types for wildcard (*) and descendents-or-self (//) operators, by incorporating the structure of the DTD into the translated regular sub-query Eₚ. The DTD structure may then also be employed to optimize the resulting XPATH sub-query by evaluating qualifiers in the sub-query p to their truth values during the translation, and thereby eliminating them.

To conduct the dynamic-programming computation, the XPathToReg algorithm uses the following variables. First, it constructs a list L that is a postorder enumeration of the nodes in the parse tree of sub-query p, such that all of the sub-queries of sub-query p (i.e., its descendants in sub-query p's parse tree) precede sub-query p in enumerated list L. Second, it puts all the element types of the DTD D in an element list N. Third, for each sub-query p in enumerated list L and each node A in element list N, the expression x2r(p, A) denotes the translated regular sub-query (or local translation) of sub-query p at each node A, which is a regular XPATH expression. Further, the expression reach(p, A) is used here to denote the types in D that are reachable from A via p. Further extending this notation, the expression reach([q], A) for a qualifier [q] denotes whether or not qualifier [q] can be evaluated to false at a given node A, indicated by whether or not reach([q], A) is empty. Finally, for each node A and its descendant B in the DTD graph G_{D} of DTD D, the expression rec(A, B) is used herein to

TABLE 4
Rewriting Algorithm from XPath to Regular XPath
Algorithm XPathToReg

Input: an XPATH query Q over a DTD D.
Output: an equivalent regular XPATH query E_{Q} over D.
1. compute the ascending list L of sub-queries in Q;
2. compute the list N of all the types in D;
3. for each p in L do
4. for each A in N do
5. if p ≠ ∈// /*x2r(∈//, A), reach(∈//, A) are precomputed */
6. then x2r(p, A) := ; reach(p, A) := ;
7. for each p in the order of L do
8. for each A in N do
9. case p of
10. (1) ∈: x2r(p, A) := ∈; reach(p, A) := {A};
11. (2) B: if B is a child type of A
12. then x2r(p, A) := B; reach(p, A) := {B};
13. else x2r(p, A) := ; reach(p, A) := ;
14. (3) *: for each child type B of A in D do
15. x2r(p, A) := x2r(p, A) ∪ B; /* ∪: XPATH operator */
16. reach(p, A) := reach(p, A) ∪ {B}; /* ∪: set union */
17. (4) p1/p2: ifx2r(p1, A) =
18. then x2r(p, A) := ; reach(p, A) := ;
19. else cons := ;
20. for each B in reach(p1, A) do
21. cons := cons ∪ x2r(p2, B);
22. reach(p, A) := reach(p, A) ∪ reach(p2, B);
23. if cons ≠
24. then x2r(p, A) := x2r(p1, A)/cons;
25. else reach(p, A) := ; x2r(p, A) := ;
26. (5) ∈//p1: /* reach, rec are already precomputed */
27. for each child C of A do
28. if p1 = B/p′ and reach(p′, B) ≠
29. then x2r(p, A) := x2r(p, A) ∪ rec(C, B)/x2r(p′, B);
reach(p, A) := reach(p′, B);
30. else for each B in reach(∈//, C) do
31. if x2r(p1, B) ≠
32. then x2r(p, A) := x2r(p, A) ∪ rec(C, B)/x2r(p1, B);
33. reach(p, A) := reach(p, A) ∪ reach(B, p1);
34. (6) p1 ∪ p2: x2r(p, A) := x2r(p1, A) ∪ x2r(p2, A);
35. reach(p, A) := reach(p1, A) ∪ reach(p2, A);
36. (7) p′[q]:
37. for each B in reach(p′, A) do
38. if x2r([q], B) = [∈] /* [q] holds at B */
39. then x2r(p, A) := x2r(p, A) ∪ x2r(p′, A);
40. reach(p, A) := reach(p, A) ∪ {B};
41. else if reach([q], B) ≠ /* [q] is not false at B */
42. then x2r(p, A) := x2r(p, A) ∪ x2r(p′, A)[x2r(q, B)];
43. reach(p, A) := reach(p, A) ∪ {B};
44. (8) [p1]: x2r(p, A) := [x2r(p1, A)];
45. reach(p, A) := reach(p1, A);
46. (9) p′[text( ) = c]: x2r(p, A) := x2r(p′, A)[text( ) = c];
47. reach(p, A) := reach(p′, A);
48. (10) [q1 [symbol] q2]: if reach(q1, A) ≠ and reach(q2, A) ≠
49. then x2r(p, A) := [x2r([q1], A) [symbol] x2r([q2], A)];
50. reach(p, A) := {true};
51. else x2r(p, A) := ; reach(p, A) := ;
52. (11) [q1 [symbol] q2]: if reach(q1, A) ≠ and reach(q2, A) ≠
53. then x2r(p, A) := [x2r([q1], A) [symbol] x2r([q2], A)];
54. else if reach(q1, A) ≠ and reach(q2, A) =
55. then x2r(p, A) := [x2r([p1], A)];
56. else if reach(q1, A) = and reach(q2, A) ≠
57. then x2r(p, A) := [x2r([p2], A)];
58. else x2r(p, A) := ;
59. reach(p, A) := reach(q1, A) ∪ reach(q2, A);
60. (12) p′[ [symbol] q]: if reach(q, B) = for all B ∈ reach(p′, A)
61. then x2r(p, A) := x2r(p′, A);
62. reach(p, A) := {true};
63. else x2r(p, A) := x2r(p′, A)[ [symbol] x2r([q], A)];
64. reach(p, A) := reach(p′, A);
65. optimize x2r(Q, r) by removing using ∪ E = E, E₁//E₂ =
66. return x2r(Q, r); /* r is the root of D */

denote the regular expression representing all the paths from node A to node B in graph G_{D}, such that the expression rec(A, B) is preferably equivalent to the XPATH query ε//B when being evaluated at an A element.

In one embodiment, the expressions rec(A, B) and reach(ε//, A) over a recursive DTD are computed with the general Kleene closure by using, e.g., the algorithm known to those of ordinary skill in the art as “Tarjan's fast algorithm,” as published in R. E. Tarjan's article entitled “Fast Algorithms For Solving Path Problems,” published in JACM 28(3):594-614, 1981. This algorithm finds a regular expression representing all the paths between two nodes in a (cyclic) graph. Thus, expressions rec(A, B) and reach(ε//, A) can be computed in the following manner:

1. for each A in N
2. for each descendant B of A do
3. rec(A, B) := the regular expression found by Tarjan's fast algorithm;
4. reach (∈//, A) := reach (∈//, A) ∪ {B};

Tarjan's fast algorithm takes O(|D| log |D|) time, and thus so is the size of rec(A, B). Note that rec(A, B) is determined by the DTD D regardless of the input query Q; thus it can be precomputed for each A, B, once and for all, and made available to XPathToReg.

Section 6.3.2 below presents an alternative algorithm for computing the expression rec(A, B).

Also of note is the special query , which returns an empty set over any XML tree, as described in Section 6.1. In the present translation algorithm, the query is used for optimization purposes. Further, unnecessary occurrences of the null set operator ε in the input query Q, are eliminated by means of rules p/ε=ε/p=p and p[ε]=p.

Algorithm XPathToReg is given in Table 4. It computes E_{Q}=x2r(Q, r) as follows. It first enumerates (a) the list L of sub-queries p in input query Q and (b) the list N of element types in D, and initializes the values of function x2r(p, A) to the special query and reach(p, A) to empty set for each pεQ and each element type AεN (lines 1-6). Then, for each sub-query p in list L in the topological order and each element type A in list N, it computes the local translation x2r(p, A) (lines 7-63), bottom-up starting from the inner-most sub-query of Q. To do so, it first computes local translation elements x2r(pᵢ, Bⱼ) for each immediate sub-query pᵢ of p at each possible DTD node Bⱼ under A (i.e., Bⱼ in reach (p, A)); then, it combines these local translation elements x2r(pᵢ, Bⱼ)'s to get the combined local translation x2r(p, A).

As seen from the algorithm itself, the details of this combination are determined based on the formation of sub-query p from its immediate sub-queries pᵢ, if any (cases 1-12). In particular, in the case p=ε//p₁ (case 5), the algorithm ranges over the children C of A to compute rec(C, _) instead of rec(A, _) since the context node A is already in the latter, where ‘_’ denotes an arbitrary type.

The special case that arises when the immediate sub-query p₁ is of the form B/p′ is handled by using rec(C, B)/x2r(p′, B). Note that when sub-query p is a qualifier [q] (cases 7-12), it may evaluate the qualifier [q] to a truth value (ε for true and for false) in certain cases based on the structure of the DTD D, thereby optimizing the query evaluation.

At the end of the iteration, the algorithm obtains the regular equivalent XPATH query E_{Q}=x2r(Q,r) by combining the local translation elements x2r(pᵢ, Bⱼ)'s to produce the combined local translation x2r(p, A). The algorithm preferably then optimizes the combined local translation by removing elements. Finally, it returns the optimized combined local translation as the output of the algorithm (lines 64-65).

### EXAMPLE 6.6

Recall the XPATH query Q₂ from Example 6.2. The algorithm of Krishnamurthy et al. cannot handle this query over the dept DTD of FIG. 1(a). In contrast, XPathToReg translates Q₂ to the following regular XPATH query E_{Q}_{₂}:

E_{Q}_{₂}=dept/course[E_{course}_{_{—}}_{course}/prereq/course/cno=“cs66” [symbol] [symbol] E_{course}_{_{—}}_{project} [symbol] [symbol] takenBy/student/E_{qualified}_{_{—}}_{course}/cno=“cs66”.

where the following is computed by Tarjan's fast algorithm:

E_{course}_{_{—}}_{course}=rec (course, course)=course/E₁*∪E₂⁺/E₁*,

E_{course}_{_{—}}_{project}=rec (course, project)=(course/E₁*∪E₂⁺/course/E₁*)/project,

E_{qualified}_{_{—}}_{course}=rec(qualified, course)=qualified/course/E₁*∪(qualified/E₂)⁺/course/E₁*,

E₁=prereq/course∪takenBy/student/qualified/course

E₂=course/E₁*/project/required

### The algorithm given in the next section below may then translate E_{Q}_{₂} to equivalent relational queries that may be evaluated directly by an RDBMS. □

Algorithm XPathToReg takes at most O(|Q|*|D|³) time, since each step in the iteration takes at most O(|D|) time, except that Case 5 may take O(|D|²) time. The size of the list L is linear in the size of Q, and the expression rec(A, B) may be precomputed as soon as the DTD D is available. Furthermore, taken together with the complexity of Tarjan's algorithm, the size of the output E_{Q} is at most O(|Q|*|D|⁴log|D|). As such, the present invention provides a method for rewriting an XPATH query Q over a DTD D to an equivalent regular XPATH expression E_{Q} over DTD D of size of at least O(|Q|*|D|⁴log|D|).

Algorithm XPathToReg has a number of highly advantageous characteristics. First, regular XPATH queries capture DTD recursion and XPATH recursion in a uniform framework by means of the general Kleene closure E*. Second, during the translation, algorithm XPathToReg conducts optimization by leveraging the structure of the DTD. Third, Kleene closure is only introduced when computing the regular expression rec(A, B); thus there are no qualifiers within a Kleene closure E* in the output regular query. Fourth, both query |Q| and DTD |D| are far smaller than the data (XML tree) size in practice.

### 6.3.2 Optimization via Cycle Contraction

A preferred criterion for computing a regular XPATH query E_{Q} is that the final output SQL query Q′ that is ultimately translated from E_{Q} should be efficient. Among the relational operators in output query Q′, the least fixed point recursion operator LFP is perhaps the most costly. Thus, it is desirable for E_{Q} to contain as few Kleene closures as possible. In other words, among possibly many regular expressions representing all the paths from a node A to another node B in a graph, it is desirable to choose that expression rec(A, B) that has a minimal number of Kleene closures E*. It is clear from Example 6.6 that the regular expressions rec(A, B) computed by the algorithm of Tarjan may contain excessively many E*'s. Indeed, the focus of Tarjan's algorithm is the efficiency for finding any regular expression representing paths between two nodes, rather than the one with the least number of Kleene closures E*. Furthermore, it is not realistic to expect an efficient algorithm to find path rec(A, B) with the least number of Kleene closures E*'s: this problem is PSPACE-hard (by reduction from the equivalence problem for regular expressions).

In response to this, the inventors have developed a new algorithm for computing the regular expression rec(A, B), referred to as Algorithm Cycle-C, which is a heuristic for reducing, and preferably minimizing, the number of Kleene closures in a resulting regular XPATH query. As will be seen below, Cycle-C outperforms the algorithm of Tarjan in many cases.

Algorithm Cycle-C is based on the idea of graph contraction: given a DTD graph G_{D}, algorithm Cycle-C repeatedly contracts simple cycles of graph G_{D} into nodes and thereby reduces the interaction between these cycles in expression rec(A, B). In short, it first enumerates all distinct simple paths (i.e., paths without repeating labels) between nodes A and B in graph G_{D}, referred to as key label paths and denoted by AB-paths.

As an example, assume that all the AB-paths are L₁, . . . , Lₙ, where each Lᵢ is of the form A₁→ . . . →Aₖ, with A=A₁ and B=Aₖ. Algorithm Cycle-C encodes each path Lᵢ with a regular expression Eᵢ, which has an initial value A₁/ . . . /Aₖ. Then, for each simple cycle Cⱼ “connected” to Aᵢ, the algorithm encodes the cycle Cⱼ with a simple regular expression E_{C}_{ⱼ}*, where E_{C}_{ⱼ} represents the simple path of cycle Cⱼ. It contracts Cⱼ to the node Aᵢ and replaces node Aᵢ in expression Eᵢ with the substitute node Aᵢ/E_{C}_{ⱼ}*. As a result of the contraction, cycles that were not directly connected to Lᵢ may become directly connected to Lᵢ. The algorithm repeats this process until all the cycles connected to Lᵢ, directly or indirectly, have been incorporated into Eᵢ. It may be verified that expression rec(A, B) is indeed (E₁∪ . . . ∪ Eₙ). Advantageously, all of the simple cycles of a directed graph can be efficiently identified by known techniques.

Below are discussed the various cases dealt with by the Cycle-C algorithm, starting from simple ones.

### Case-1. A DTD graph G_{D} has a single AB-path L=A₁→ . . . →Aₖ and a single simple cycle C connected to L.

First, assume that AᵢεG_{D} is the only node shared by L and C=Aᵢ→A′₁→ . . . →A′ₘ→Aᵢ. Then, the regular expression E=Eₐ/E_{γ}/E_{b} captures all the paths between A and B, where Eₐ=A₁/ . . . /Aᵢ, E_{b}=Aᵢ₊₁/ . . . /Aₖ, and E_{γ} is E_{C}* with E_{C}=A′₁/ . . . /A′ₘ/Aᵢ.

Second, suppose that L and cycle C share more than one node, say, nodes Aᵢ and Aⱼ. In this case, cycle C only needs to be incorporated into E at one of those nodes, either at node Aᵢ or node Aⱼ, because E_{γ} has already covered the connections between nodes Aᵢ and Aⱼ. Thus regular expression E is the same as the one given above. This property allows us to find E_{γ} using an arbitrary node Aᵢ shared by multiple simple cycles.

Case-2. There exist a single AB-path L and multiple simple cycles C₁, . . . , Cₙ, while all these cycles share a single node Aᵢ on L. Here the regular expression E is a mild extension of case-1: E is Eₐ/E_{γ}/E_{b} while E_{γ}=(E_{C}_{₁}∪E_{C}_{₂}∪ . . . ∪E_{C}_{ₙ})*, and E_{C}_{ᵢ} codes Cᵢ as above.

### EXAMPLE 6.7

A case similar to Case 2 was given in Example 6.5. Consider the expression R_{d}//Rₚ over the DTD graph FIG. 1(b). The graph has 3 simple cycles: (a) R_{c}→R_{c}, (b) Rₛ→R_{c} and (c) R_{c}→Rₚ→R_{c}. The only AB-path is path L=R_{d}→R_{c}→Rₚ (i.e, dept course project). Here, node R_{c} is the node shared by all the three cycles and L. The resulting regular XPATH query is then R_{d}/R_{c}/((R_{c}∪Rₛ/R_{c}∪Rₚ/R_{c})*)/Rₚ. □

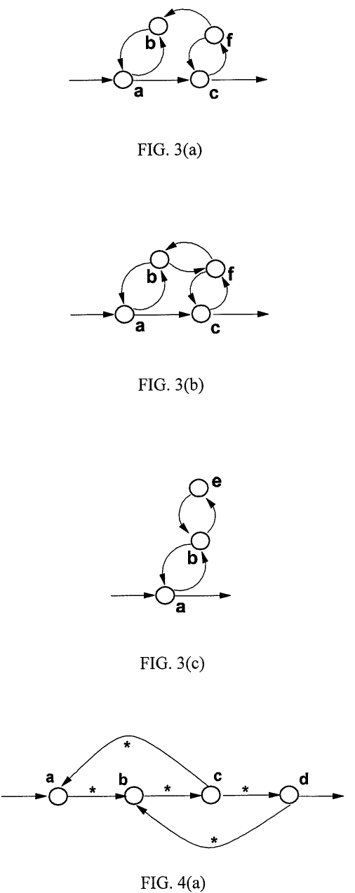

Case-3. There exist a single AB-path L and multiple simple cycles C₁, . . . , Cₙ, but not all the cycles share a node on L. For example, FIG. 3(a) shows a DTD graph with 3 simple cycles (a) C₁=a→b→a, (b) C₂=c→f→c, and (c) C₃=a→c→f→b→a. Consider rec(a, c), for which the only AB-path is L=a→c. While cycles C₁ and C₃ share a on L, and cycles C₂ and C₃ share c, but not all three cycles share a or c as a common node. Given the above, algorithm Cycle-C first generates expression E=a/c. Then, it contracts cycles C₁, C₃ and replaces a with a regular expression a/E_{γ1}, capturing paths from a to a via C₁ and C₃. It then contracts C₂ and C₃ by replacing c with c/E_{γ2}, covering paths from c to c via C₂ and C₃. The final result is E=a/E_{γ1}/c/E_{γ2}.

Observe the following. First, E_{γ2} covers all possible paths that traverse E_{γ1} since E_{γ2} includes E_{γ1} by replacing a with E_{γ1}, and E covers all possible paths between a and c. Second, the processing order of the cycles is not sensitive. One may first process C₂ and C₃ and obtain E_{γ2}, and then let E_{γ1} include E_{γ2} by replacing c with E_{γ2}.

Case-4. There are multiple AB-paths. FIG. 3(b) shows a DTD graph with 4 simple cycles: (a) cycle C₁=a→b→a, (b) cycle C₂=c→f→c, (c) cycle C₃=a→c→f→b→a, and (d) cycle C₄=b→f→b. It may be seen that expression rec(a, c) has two AB-paths: path L₁=a→c, and path L₂=a→b→f→c. On path L₁ there are three simple cycles C₁, C₂ and C₃, and on path L₂ there are cycles C₁, C₂ and C₄. Here, the regular XPATH query is E_{L}_{₁}∪E_{L}_{₂}, where each E_{L}_{₁} is generated based on the single AB-path cases above.

Case-5. There are a single AB-path L and multiple simple cycles, but not all cycles are directly connected to path L. For example, FIG. 3(c) shows a DTD graph with 2 simple cycles: cycle C₁=a→b→a and cycle C₂=b→e→b. Consider rec(a, a), for which the AB-path is a. Note that C₂ does not directly connect to a, but it is on C₁. In accordance with the Cycle-C algorithm, cycle C₂ is processed in the following steps: (1) generate a regular expression E=a; (2) contract C₂, generate E_{C}_{₂} to capture C₂ and replace b in C₁ with b/E_{C}_{₂}; and (3) contract C₁ and replace a with a/E_{C}_{₁}, which includes E_{C}_{₂}.

Putting these cases together, the Cycle-C algorithm is presented in Table 5. It takes as inputs a DTD graph GD and nodes A and B in DTD graph G_{D}, and returns a regular expression rec(A, B) as its output.

More specifically, the Cycle-C algorithm first identifies all the AB-paths L₁, . . . , Lₙ in G_{D} and for each path Lᵢ, finds the subgraph Gᵢ that consists of that path Lᵢ along with all the simple cycles that are connected to that path Lᵢ, directly or indirectly (lines 1-2). The simple cycles Cᵢ connected to each path Lᵢ are preferably determined using a known algorithm such as that described by H. Weinblatt in his article entitled “A New Search Algorithm for Finding the Simple Cycles of a Finite Directed Graph,” JACM 19(1):43-56, 1972. Second, after determining the simple cycles Cᵢ connected to a given path Lᵢ, the Cycle-C algorithm then topologically sorts these cycles based on their shortest distance to any node on the path Lᵢ(line 6). Third, for each of these cycles starting from the one with the longest distance to Lᵢ, it contracts the cycle based on case-5 above (lines 4-12). Fourth, it identifies

TABLE 5
Algorithm for Computing rec(A, B)
Algorithm Cycle-C(G_{D}, A, B)

```
Input: a DTD graph G_{D} and two nodes A, B in G _{D}.
output: a regular expression rec(A, B) in G _{D}.
1. find all distinctive AB-paths, L₁, L₂, ... , Lₖ, between A and B;
2. for each Lᵢ do
3. Gᵢ := the subgraph including all simple cycles that
          are connected Lᵢ directly and indirectly;
4. for each Lᵢ = A₁ → ... → Aₖ do
5. Eᵢ := A₁/ .../Aₖ;
6. Cᵢ := a list of all simple cycles in Gᵢ found by Weinblatt algorithm
        and sorted in topological order based on their distance to Lᵢ
        from the farthest to those directly connected to Lᵢ;
7. for each cycle C in Cᵢ in the order of Cᵢ do
8. if C does not directly connect to Lᵢ
9. then find node Aₓ on C with the shortest distance to Lᵢ;
10. Gₓ := the subgraph consisting of C;
11. E_{C} := Cycle-C(Gₓ, Aₓ, Aₓ); /* contract C to Aₓ */
12. replace Aₓ and C with E*_{C} in Gᵢ;
13. identify the nodes A′₁, ... , A′ₘ shared by simple cycles with Lᵢ;
14. for each A′ᵢ shared by cycles C₁, ..., Cₗ
15. E_{A}_{J} := a regular expression representing C₁, ..., Cₗ,
            computed based on cases 1–3 described earlier;
16. replace Aⱼ in Eᵢ with Aⱼ/E*_{A′}ⱼ;
17. return E = E₁ ∪ ... ∪ Eₙ;
```

all Aⱼ nodes shared by some simple cycles (line 13) with path Lᵢ, and contracts those simple cycles to a single node based on cases 1-3 above (lines 14-16). Finally, it produces and returns the resulting regular expression based on case 4 above (line 17). Advantageously, the resulting regular expression rec(A, B) returned by algorithm Cycle-C captures all and only the paths between nodes A and B in DTD graph G_{D}.

### EXAMPLE 6.8

Recall the regular XPATH query E_{Q}_{₂} from Example 6.6 above, which is generated from the XPATH query Q₂ by algorithm XPathToReg. Applying algorithm Cycle-C, one obtains:

E_{course}_{_{—}}_{course}=course/E_{cc},

E_{course}_{_{—}}_{project}=course/E_{cc}/project,

E_{qualified}_{_{—}}_{course}=qualfied/course/E_{cc},

E=(E₁∪project/required/course)*,

E₁ is the same as the one given in Example 6.6.

### These are notably simpler than their counterparts in Example 6.6 computed by Tarjan's algorithm. □

### 6.4 From Regular XPath Expressions to SQL

This section describes an algorithm embodying the second step of the present invention as described above, namely, rewriting regular XPATH queries into SQL with the simple LFP operator. An optimization technique for pushing selections into LFP is also provided below.

### 6.4.1 Translation Algorithm

An algorithm for rewriting regular XPATH queries into an equivalent SQL query in accordance with the invention is as follows: given a mapping τ_{d}: D→R from XML trees of a DTD D to relations of a schema R and further given a regular XPATH query E_{Q} over DTD D, a sequence Q′ of equivalent relational-algebra (“RA”) queries is computed with the simple LFP operator 4 such that the equivalent SQL query E_{Q}(T)=sequenceQ′(τ_{d}(T)) for any XML tree T of DTD D. The relational algebra query Q′ can be easily coded in SQL.

An issue that arises with this approach is that the LFP operator Φ supports the (E)⁺ but not (E)* operation. (In relational algebraic terms, the (E)* operation means repeating E zero or more times, while the (E)⁺ operation indicates repeating E at least once.) Thus, any (E)* expressions in the regular XPATH query E_{Q} are preferably converted to ε∪(E)⁺ (that is, the union of the null set with the (E)⁺ terms). To simplify the handling of the null set ε, a relation R_{id} is assumed to consist of tuples (v, v, v.val) for all nodes (IDs) v in the input XML tree except the root r. Note that in relational algebra, R_{id} is the identity relation for the join operation: R [symbol] R_{id}=R_{id} [symbol] R=R for any relation R. With this assumption, the expression (E)* may be translated to Φ(R)∪R_{id}, where R codes E and R_{id} tuples will be eliminated at a later stage. To simplify the presentation of the translation algorithm, null set ε is re-written here into R_{id}. In practice, other more efficient translations may be used in accordance with known techniques.

The translation algorithm RegToSQ L for rewriting regular XPATH expressions to SQL, is shown

TABLE 6
Rewriting Algorithm from Regular XPath to SQL
Algorithm RegToSQL

```
Input: a regular XPATH expression E_{Q} over a DTD D.
Output: an equivalent list Q′ of RA queries over [symbol] , where τ : D → [symbol] .
1. compute the ascending list L of sub-expressions in E;
2. Q′ := empty list [ ];
3. for each e in the order of L do
4. case e of
5. (1) ∈: r2s(e) := R_{id};
6. (2) A: r2s(e) := R_{A};
7. (3) e₁/e₂: let R₁ = r2s(e₁), R₂ = r2s(e₂);
8. r2s(e) := Π_{R}_{₁}_{.F,R}_{₂}_{.T,R}_{₂}_{.V}(R₁ [symbol] _{R}_{₁}_{.T=R}_{₂}_{.F} R₂);
9. (4) e₁ ∪ e₂: let R₁ = r2s(e₁), R₂ = r2s(e₂);
10. r2s(e) := R₁ ∪ R₂;
11. (5) E*: let R = r2s(e);
12. r2s(e) := Φ(R) ∪ R_{id};
13. (6) e₁[q]: let R₁ = r2s(e₁), R_{q} = r2s(q);
14. r2s(e) := Π_{R}_{₁}_{.F,R}_{₂}_{.T,R}_{₂}_{.V}(R₁ [symbol] _{R}_{₁}_{.T=R}_{_{q}}_{.F} R_{q});
            /* returns R₁ tuples that connect with R₂ tuples */
15. (7) [e₁]: r2s(e) :=r2s(e₁);
16. (8) e₁[text( ) = c]: let R₁ = r2s(e₁);
17. r2s(e) := σ_{R}₁.V=cR₁;
                /* select tuples t of R₁ with t.V = c */
18. (9) [q₁ [symbol] q₂]: let R₁ = r2s(q₁); R₂ = r2s(q₂);
19. r2s(e) := R₁ ∪ R₂ \ ((R₁ \ R₂) ∪ (R₂ \ R₁));
              /* r2s(e) = R₁ ∩ R₂; */
20. (10) [q₁ [symbol] q₂]: let R₁ = r2s(q₁); R₂ = r2s(q₂);
21. r2s(e) := R₁ ∪ R₂;
22. (11) e₁[ [symbol] q]: let R_{q} = r2s(q), R₁ = r2s(e₁);
23. r2s(e) := R₁\ Π_{R}_{₁}_{.F,R}_{₂}_{.T,R}_{₂}_{.V}
                  (R₁ [symbol] _{R}_{₁}_{.T=R}_{_{q}}_{.F} R_{q});
              /* only R₁ tuples not connecting to any R_{q} tuple */
24. Q′ := (Rₑ ← r2s(e)) :: Q′; /* add r2s(e) to Q′ */
25. r2s(E_{Q}) := σF=’_’r2s(E_{Q}); /* select nodes reachable from root */
26. Q′ := r2s(E_{Q}) :: Q′;
27. optimize Q′ by extracting common sub-queries;
28. return Q′;
```

in Table 6. The algorithm receives a regular XPATH query E_{Q} over the DTD D as input, and returns an equivalent sequence Q′ of relational algebra queries with the LFP operator Φ as output.

The algorithm is based on dynamic programming: for each sub-expression e of regular XPATH query E_{Q}, it computes r2s(e), which is the relational algebra query translation of e; it then associates r2s(e) with a temporary table Rₑ (which is used in later queries) and increments the list Q′ with R←r2s(e). r2s(e) is preferably computed from r2s(eᵢ) where eᵢ's are the immediate sub-queries of sub-expression e. Thus, upon the completion of the processing the algorithm produces the list Q′ equivalent to E_{Q}.

More specifically, the algorithm first finds the list L of all sub-expressions of regular XPATH query E_{Q} and topologically sorts them in ascending order (line 1). Then, for each sub-query e in list L, it computes RA query translation r2s(e) (lines 3-23), in a “bottom-up” fashion starting from the inner-most sub-query of E_{Q}, and based on the structure of e (cases 1-11). In particular, the various cases of expression e are encoded as follows.

(1) A label A in terms of the relation R_{A} (case 2).

(2) Concatenation ‘/’ with projection Π and join [symbol] (case 3).

(3) Union and disjunction with union ∪ in relational algebra (cases 4, 10).

(4) Kleene closure (E)* with the LFP operator φ (case 5).

(5) e₁[q] is converted to a relational algebra query r2s(e) that returns only those r2s(e₁) tuples t₁ for which there exists a r2s(q) tuple t₂ with t₁.T=t₂.F, i.e., when the qualifier q is satisfied at the node represented by t₁.T (case 6). On the other hand, the algorithm rewrites e₁[ [symbol] q] to a relational algebra query r2s(e) that returns only those r2s(e₁) tuples t₁ for which there exists no r2s(q) tuple t₂ such that t₁.T=t₂.F, i.e., when the qualifier q is not satisfied at the node t₁.T (and hence [ [symbol] q] is satisfied at t₁.T; case 11); this captures the semantics of negation in XPATH (recall the assumptions about [ [symbol] q] and [text( )=c] set forth in Section 6.1 above).

(6) [e₁] is rewritten into r2s(e₁) (case 7).

(7) e₁[text( )=c] in terms of selection σ that returns all tuples of r2s(e₁) that have the text value c (case 8).

(8) Conjunction q₁ [symbol] q₂ in terms of set intersection implemented with union U and set difference \ in relational algebra (case 9).

In each of the cases above, the list Q′ is incremented by adding Rₑ←r2s(e) to Q′ as the head of Q′ (line 24).

Finally, after the iteration, the algorithm yields π_{T}σ_{F=‘}_{_{—}}_{’}r2s(E_{Q}) (line 25), which selects only those nodes reachable from the root of the XML tree. The algorithm thereby removes unreachable nodes, including those introduced by R_{id}. In addition, the algorithm preferably also reduces (or more preferably optimizes) the sequence Q′ of relational algebra queries by eliminating empty sets ε and extracting common sub-queries (details omitted from Table 6). Finally, the algorithm returns the cleaned list Q′ as output (lines 27-28). The outputted list Q′, in its reverse order, is a sequence of relational algebra queries equivalent to the regular XPATH query E_{Q}.

### EXAMPLE 6.9

Recall the XPATH query Q₂ from Example 6.2, and its regular XPATH translation E_{Q}_{₂} from Example 6.6, which contains E_{course}_{_{—}}_{course}, E_{course}_{_{—}}_{project} and E_{qualified}_{_{—}}_{course} generated by Cycle-C and given at the end of Section 6.3. Given E_{Q}_{₂}, the RegToSQL algorithm generates the relational algebra translation below:

E_{cc}: R_{γ} with LFP, the same as the one in Example 6.5.

E_{course}_{_{—}}_{course}: R_{cc}←R_{c} [symbol] R_{γ},

E_{course}_{_{—}}_{project}: R_{cp}←R_{c} [symbol] R_{γ} [symbol] Rₚ,

E_{qualified}_{_{—}}_{course}: R_{qc}←R_{cc,}

E_{course}_{_{—}}_{course}/prereq/course/cno=“cs66”:R₁←σ_{cno=“cs66”} (R_{cc} [symbol] R_{c})

takenBy/student/E_{qualified}_{_{—}}_{course}/cno=“cs66”:R₂←σ_{cno=“cs66”}(Rₛ [symbol] R_{qc})

Note that Q₂ is of the form (with a complex qualifier) dept/course[q₁ [symbol] [symbol] q₂ [symbol] [symbol] q₃], which is handled by our algorithms by treating it as Q₂¹=dept/course[q₁], Q₂²=Q₂¹[ [symbol] q₂] and Q₂=Q₂²[ [symbol] q₃]. Thus Q₂¹←R_{d} [symbol] R_{c} [symbol] R₁, Q₂²←Q₂¹\(Q₂¹ [symbol] R_{cp}), and E_{Q}_{₂} becomes Q₂²\(Q₂² [symbol] R₂) where projections are omitted. In contrast, the algorithm of Krishnamurthy et al. cannot translate XPATH queries of this form. □

It can be verified that algorithm RegToSQL takes at most O(|E_{Q}|) time. As such, it will be understood that the present invention, comprising the steps set out in algorithms XPathToReg and RegToSQL, provides a method for rewriting each XPATH query Q over a DTD D to an equivalent sequence of SQL queries (with the LFP operator) of total size O(|Q|*|D|⁴log|D|).

Observe the following. First, algorithm RegToSQL shows that the simple LFP operator (R) suffices to express XPATH queries over recursive DTDS; thus there is no need for the advanced SQL'99 recursion operator. Second, the total size of the produced SQL queries is bounded by a low polynomial of the sizes of the input XPATH query Q and the DTD D. Finally, the algorithms XPathToReg and RegToSQL can be combined into one, although they are presented separately herein in order to focus on their respective functionality.

### 6.4.2 Pushing Selections into the LFP Operator

Algorithms XPathToReg and RegToSQL show that SQL with the simple LFP operator is powerful enough to answer XPATH queries over recursive DTDS. While certain optimizations are already conducted during the translation, other known techniques, e.g., sophisticated methods for pushing selections/projections into the LFP operator can be incorporated into the above translation algorithms to further optimize the generated relational queries.

In particular, selections may be pushed into LFP in the following exemplary manner (although others may be used). Consider an XPATH query Q₃=R_{d}[id=a]/R_{c}//Rₚ. To simplify the discussion, assume that the XPathToReg and RegToSQL algorithms rewrite Q₃ into R₁←Q_{d} and R₂←LFP(R₀), where Q_{d} and LFP(R₀) compute R_{d}[id=a] and R_{c}//Rₚ, respectively. While R₁ [symbol] R₂ yields the right answer, the performance may be improved by pushing the selection into the LFP computation such that it only traverses “paths” starting from the R_{c} children of those R_{d} nodes with id=a. Recall from Eq. (2) that one can specify a predicate C on the join between R_{φ} and R₀ in LFP, where R₀ is the input relation and R_{φ} is the relation being computed by the LFP (see Section 6.2 above; supported by connectby of Oracle and with . . . recursion of IBM DB2). Here the predicate C can be given as R_{Φ}.Fεπ_{T}(R₁) R_{Φ}.T=R₀.F (‘ε’ denotes in in SQL), i.e., besides the equijoin R_{Φ}.T=R₀.F, the F (from) attribute of R_{Φ} should match a T (to) attribute of R₁. Then, each iteration of the LFP only adds tuples (f, t), where f is a child of a node in π_{T}(R₁).

Similarly, the selection in R_{d}//R_{c}/Rₚ[id=c] can be pushed into LFP(R₀) for rec(R_{d}, R_{c}). Indeed, let R₁ be the relation found for Rₚ[id=c], and the LFP join condition be: R_{Φ}.F=R₀.T R_{Φ}.Tεπ_{F}(R₁). Then the LFP operation only returns tuples of the form (f, t), where t is the parent of a node in π_{F}(R₁). As will be seen in Section 6.5 below, this optimization is effective.

### 6.5 A Performance Study

To verify the effectiveness of the rewriting and optimization algorithms presented above, the inventors evaluated XPATH queries using an RDBMS with three approaches: (1) the SQLGen-R algorithm of Krishnamurthy et al. using the with . . . recursive operator, (2) the XPathToReg and RegToSQL algorithms described above, using Tarjan's method (referred to as Cycle-E as it is based on cycle expansion) to find rec(A, B), i.e., paths from node A to B in a DTD graph, and (3) the XPathToReg and RegToSQL algorithms described above, using Cycle-C of Table 5 to compute rec(A, B), referred to as Cycle-C.

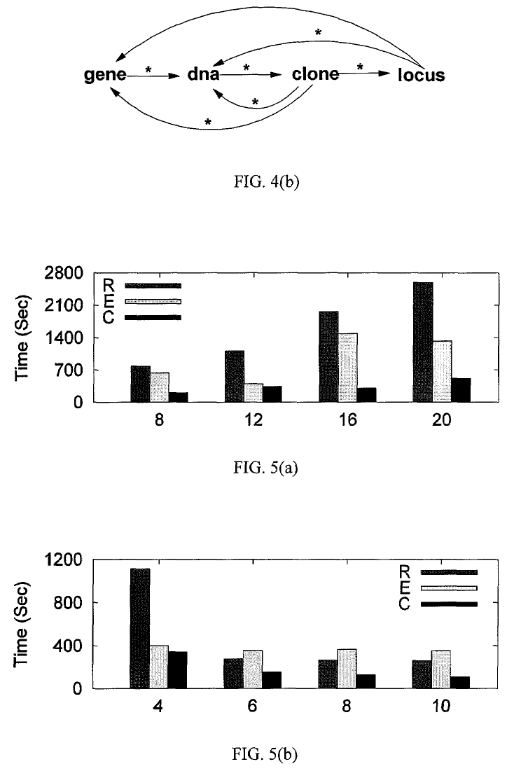

The present inventors experimented with these algorithms using (a) a simple yet representative DTD depicted in FIG. 4(a) (2 cross cycles), and (b) a real-life DTD as shown in FIG. 4(b), which is a 4-cycle DTD extracted from BIOML.

Implementation. The inventors implemented a prototype system supporting SQLGen-R, Cycle-E and Cycle-C, using Visual C++, denoted by R, E and C in the figures, respectively. Rewritten SQL queries were executed in a batch. This prototype system included only certain basic optimizations, e.g., common sub-expressions were executed only once. Experiments were conducted using IBM DB2 (UDB 7) on a single 2 GHz CPU with 1 GB main memory. The queries output ancestor-descendant pairs.

Testing Data: Testing data was generated using IBM XML Generator (http://www.alphaworks.ibm.com). The input to the Generator is a DTD file and a set of parameters. Two parameters, X_{L} and X_{R}, were primarily controlled, where X_{L} is the maximum number of levels in the resulting XML tree, and X_{R} is the maximum number of children of any node in the tree. Together X_{L} and X_{R} determine the shape of an XML tree: the larger the X_{L} value, the deeper the generated XML tree; and the larger the X_{R} value, the wider the tree. The default values used in our testing for X_{L} and X_{R} were 4 and 12, respectively. The default number of elements in a generated XML tree was 120,000. There is a need to control the sizes of XML trees to be the same in different settings for comparison purposes, and thus excessively large XML trees generated were trimmed. The other parameters of the Generator remained at its default settings.

Relational Database. Once generated, the XML testing data was mapped to a relational database using the known technique of shared-inlining. Indexes were generated for all possible joined attributes.

Query Evaluation. (1) Four XPATH queries were tested using different databases (fixing the database size while varying the relations sizes). (2) The optimization technique of Section 6.4.2 was evaluated by comparing SQL queries translated from XPATH queries with and without pushing selections into the LFP operator. (3) The scalability of our generated SQL queries with regard to different database sizes was tested using a query containing the // descendants-or-self axis specifier. These were conducted with the simple cross-cycle DTD graph. (4) Several XPATH queries were tested with various DTDS that are subgraphs of the real-life BIOML DTD, using the same database. The main difference between (1) and (4) is that the former tested the same queries with different databases, and the latter tested different queries with the same database.

### 6.5.1 Exp-1: Evaluation of Selective Queries

For the simple cross-cycle DTD (FIG. 4(a)), the following four XPATH queries were tested:

Q_{α}=α/b//c/d (with //),

Q_{b}=α[ε//c]//d (a twig join query),

Q_{c}=α[ [symbol] ε//c] (with [symbol] and //), and

Q_{d}=α[ [symbol] ε//c [symbol] (b [symbol] ε//d)] (with [symbol] , 77 , [symbol] and //).

The XPathToReg algorithm rewrites these queries into four XPATH regular queries, namely, Q′_{α}=α/E_{b,c}/d, Q′_{b}a[E_{a,b}/c]/E_{a,c}/d, Q′_{c}=α[ [symbol] E_{a,b}/c], and Q′_{d}=α[ [symbol] E_{a,b}/c [symbol] (b [symbol] E_{a,c}/d)], while the Cycle-E algorithm generates:

E_{b,c}=rec(b,c)=(E_{bb}∪(E_{bb}/c/α/(E_{bb}/c/a)*/E_{bb}))/c

E_{a,b}=rec(α,b)=α/(E_{bb}/c/α)*/E_{bb}

E_{a,c}=rec(α,c)=α/(E_{bb}/c/α)*/E_{bb}/c

E_{bb}=b/(c/d/b)*

In contrast, Cycle-C generates the following:

E_{b,c}=rec(b,c)=b/(c/α/b∪c/d/b)*/c,

E_{a,b}=rec(α,b)=α/b/(c/α/b∪c/d/b)*,

E_{a,c}=rec(α,c)=α/b/(c/α/b∪c/d/b)*/c.

For each expression rec(A,B), the Cycle-C algorithm uses one LEP,but the Cycle-E algorithm uses two LEP's. Since the last three XPATH queries cannot be handled by SQLGen-R, SQLGen-R was tested by generating a with . . . recursive query for each rec(A,B) in our translation framework. The DTD has 4 nodes and 5 edges, and SQLGen-R produced a with . . . recursive using 5 joins and 5 unions, which are computed in each iteration.

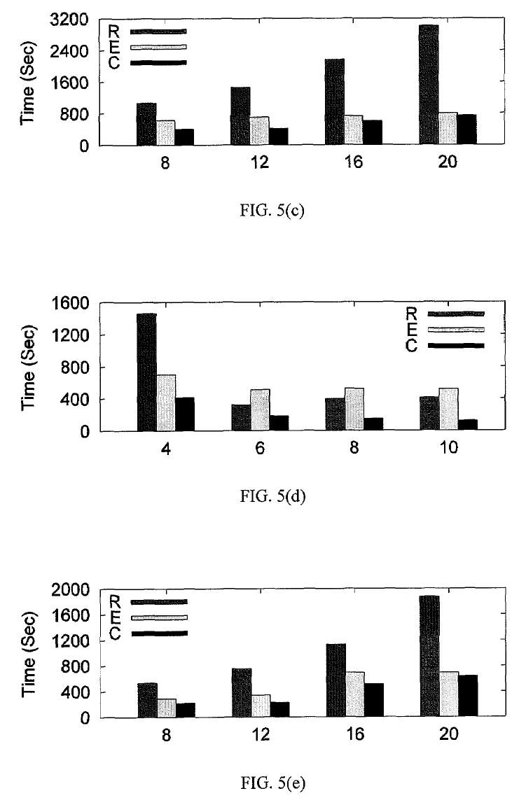

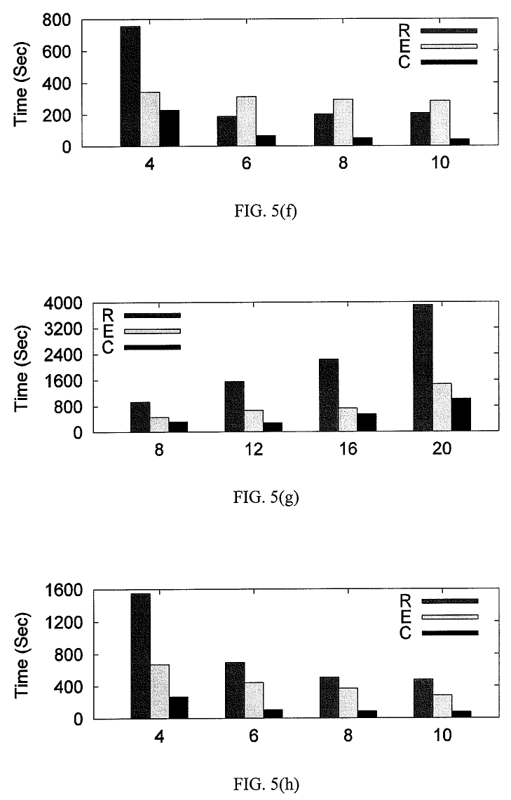

These tests used an XML tree with a fixed size of 120,000 elements. The same queries were evaluated over different shapes of XML tree controlled by the height of the tree (X_{L}) and the width of the tree (X_{L}). Since an XML tree with different heights and/or widths results in relations of different sizes in a database, even though the database size is fixed, the same SQL query generated may end up having different query-processing costs. The elapsed time (seconds for each query are depicted in FIGS. 5(a) through (h): one figure shows the elapsed time while varying X_{L} from 8 to 20 with X_{R}=4, and the other shows the time while varying Xᵣ from 4 to 10 with X_{L}=12. In all the cases, the Cycle-C algorithm noticeably outperforms the SQLGen-R and Cycle-E algorithms.

### 6.5.2 Exp-2: Pushing Selections into LFP

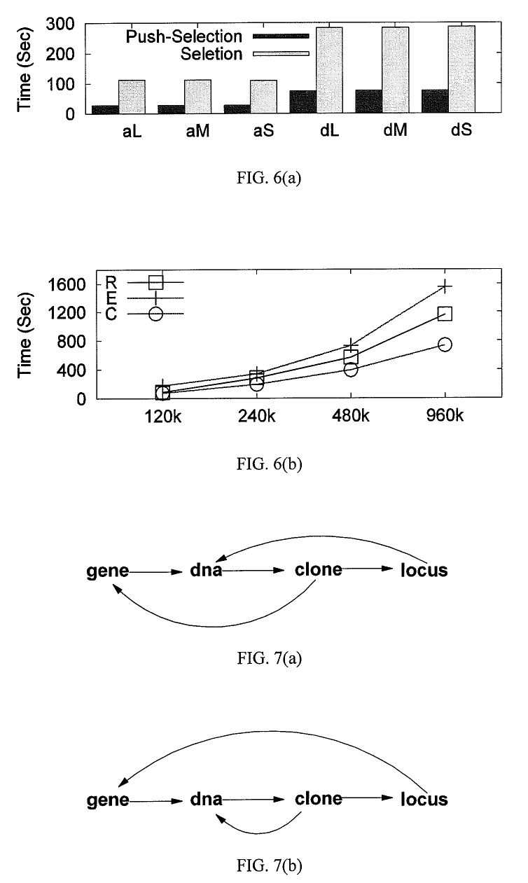

Two XPATH queries were tested with selection conditions: Qₑ=α[id=Aᵢ]/b//c/d, Q_{f}=α/b//c/d[id=Dᵢ]/ For each query, two SQL queries were generated—one with selections pushed into LFP and the other without. These queries were evaluated using datasets of the DTD of FIG. 4(a), fixing the size of eh datasets while varying the size of the set selected by the qualifiers of αᵢ and Dᵢ. FIG. 6(a) shows the result, in which (1) αL, αM and αS indicate that an αᵢ element has large/medium/small number of d descendants; and (2) dL, dM and dS indicate that a dᵢ element has large/medium/small number of α ancestors, respectively. It shows that performance improvement by pushing selections into the LFP operator is significant.

### 6.5.3 Exp-3: Scalability Test

FIG. 6(b) demonstrates the scalability of the algorithms described herein by increasing the dataset sizes, foe an XPATH query a//d over the cross-cycle DTD (FIG. 4(a)). The XML dataset size increases to 960,000 elements from 120,000. X_{L} was set to 16 because the default X_{L}=12 was to large enough for the XML generator to produce such large datasets. It was found that Cycle-C outperforms both SQLGen-R and Cycle-E noticeably, and SQLGen-R outperforms Cycle-E. When the dataset size is 960,000, the costs of Cycle-E and SQLGen-R are 2.1 times and 1.58 times of the cost of Cycle-C, respectively. This shows that when dataset is large, the present optimization technique (Cycle-C) outperforms SQLGen-R by reducing the use of LFP operators and unnecessary joins and unions. Moreover, Cycle-C linearly scalable.

### Exp-4: Complex Cycles from Real-Life DTD

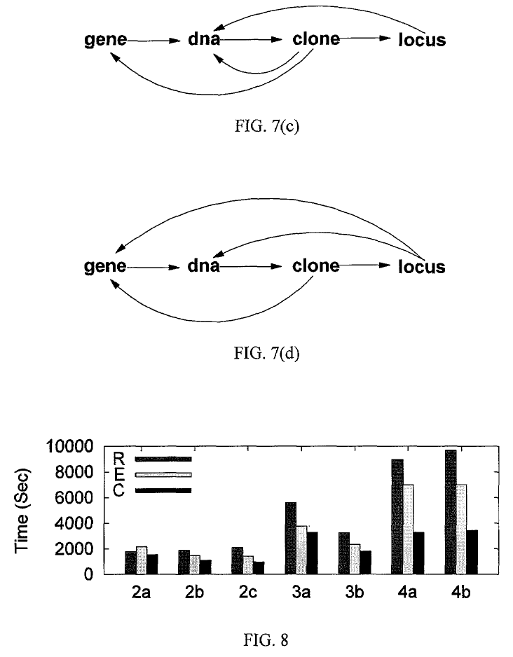

XPATH queries were also evaluated on an extracted 4-cycle BIOML DTD. Four subgraphs, as shown in FIG. 7, of the BIOML DTD of FIG. 4(b) were considered, in order to demonstrate the impact of different DTDs on the translated SQL queries. Similar XPATH queries were tested on top of these extracted DTDs, and are summarized in Table 7.

All these XPATH queries were run on the same dataset which was generated using the largest 4-cycle DTD graph extracted from BIOML (FIG. 4(b)) with X_{R}=6 and X_{l =}16. Unlike Exp-1, the XML tree generated by the IBM XMLGenerator were not trimmed for this evaluation. The generated dataset consists of 1,990,858 elements, which is 16 times larger than the dataset (120,000 elements) used in Exp-1. The sizes of relations for gene, dna, clone and locus are 354,289; 703,249; 697,060

TABLE 7
XPATH queries over different DTDs from BIOML

| Case | Query | n-Cycles | DTD Graph |
|---|---|---|---|
| 2a | gene//locus | 2 | FIG. 7(a) |
| 2b | gene//locus | 2 | FIG. 7(b) |
| 2c | gene//dna | 2 | FIG. 7(b) |
| 3a | gene//locus | 3 | FIG. 7(c) |
| 3b | gene//locus | 3 | FIG. 7(d) |
| 4a | gene//locus | 4 | FIG. 4(b) |
| 4b | gene//dna | 4 | FIG. 4(b) |

and 236,260, respectively.

As shown in FIG. 8, Cycle-C significantly outperforms SQLGen-R and Cycle-E in all the cases, and except case 2a, Cycle-E outperforms SQLGen-R. In case 4a, for example, SQLGen-R needs 7 joins and 7 unions in each iteration; Cycle-E needs to process 6 join, 2 LFP and 3 union operators; and Cycle-C uses 5 joins, 1 LFP and 4 unions operators. Note that because the Cycle-E execution sequence is determined by Tarjan's algorithm, it is too inflexible to change the order of execution. As such, Cycle-C outperforms SQLGen-R and Cycle-E because it produces fewer joins and LFP operations.

### 6.6 Conclusion

These has been provided a new approach to translating a practical class of XPATH queries over recursive DTDs to SQL queries with a simple LFP operator found in many commercial RDBMS. The approach employs efficient algorithms for rewriting an XPATH query over a recursive DTD into an equivalent regular XPATH query that captures both DTD recursion, and for translating a regular XPATH query to an equivalent sequence of SQL queries, as well as in new optimization techniques for minimizing the use of the LFP operator and for pushing selections into LFP. These provide the capability of answering important XPATH queries with the immediate reach of most commercial RDBMS.

Although the invention has been described in language specific to XPATH and various structural features and/or methodological acts, it is to be understood that the invention defined in the appended claims is not necessarily limited to the specific features or acts described. Rather, the specific features and acts are disclosed as exemplary forms of implementing the claimed invention.

We claim:

1. A method for translating an input query Q over a DTD D to an SQL query, comprising the steps of:
(a) converting the input query Q to a regular query E_{q} over the DTD D; and
(b) converting the regular query E_{q} into an equivalent sequence of SQL queries Q′.

2. The method of claim 1, wherein the regular query E_{q} is an extension of the input query Q that allows Kleene closure of one or more expressions,
whereby interaction between recursion in the input query Q and recursion in the DTD D is captured.

3. The method of claim 1, wherein step (a) comprises the step of:
(c) computing, based on a sub-query p of the input query Q, a translated regular sub-query Eₚ.

4. The method of claim 3, wherein step (c) comprises the step of:
(d) evaluating the sub-query p over at least one sub-graph of the DTD rooted at an element type. cm 5. The method of claim 4, wherein step (d) comprises the step of:
(e) substituting a regular expression for one or more of (i) a wildcard (*) operator and (ii) a descendents-or-self (//) operator.

6. The method of claim 3, wherein step (a) further comprises the step of:

7. The method of claim 3, wherein step (a) further comprises the step of:
(g) combining two or more translated regular sub-queries to produce the regular query E_{q}.

8. The method of claim 1, wherein step (a) further comprises the step of:
(h) identifying two or more sub-queries p of the input query Q; and
(i) topologically sorting the two or more sub-queries p.

9. The method of claim 1, wherein step (b) is performed using a least fixpoint operator LFP.

10. The method of claim 1, wherein step (b) comprises the steps of:
(j) computing, for a sub-expression e of the regular query E_{Q}, a relational algebra query translation of the sub-expression e.

11. The method of claim 10, wherein step (b) further comprises the steps of:
(k) associating the relational algebra query translation of the sub-expression e with a temporary table Rₑ; and
(l) incrementing a list Q′ with an element from the temporary table Rₑ.

12. The method of claim 11, wherein step (b) further comprises the step of:
(m) repeating steps (k) and (l) for each sub-expression e of the regular query E_{Q} until the list Q′ is equivalent to the regular query E_{Q}.

13. The method of claim 1, wherein step (b) further comprises the steps of:
(n) identifying two or more sub-expressions of the regular query E_{Q}; and
(o) topologically sorting the two or more sub-expressions.

14. The method of claim 1, further comprising the step of:
(p) reducing the regular query E_{Q} by one or more of (i) eliminating empty sets e and (ii) extracting common sub-queries.

15. The method of claim 1, wherein the input query Q and the regular query E_{Q} are writing in the XPATH language.

16. An interface for translating an input query Q over a DTD D to an SQL query, comprising a processor configured to execute the following steps:
(a) converting the query Q to a regular query E_{Q} over the DTD D; and
(b) converting the regular query E_{Q} into an sequence of SQL queries Q′.

17. The interface of claim 16, wherein the regular query E_{Q} extends the input query Q by allowing Kleene closure of one or more path expressions,
whereby interaction between recursion in the input query Q and recursion in the DTD D is captured.

18. The interface of claim 16, wherein step (a) comprises the steps of:
(c) computing, based on a sub-query p of the input query Q, a translated regular sub-query Eₚ.

19. The interface of claim 18, wherein step (c) comprises the step of: (d) evaluating the sub-query p over at least one sub-graph of the DTD rooted at an element type.

20. The interface of claim 19, wherein step (d) comprises the step of:
(e) substituting a regular expression for one or more of (i) a wildcard (*) operator and (ii) a descendants-or-self (//) operator.

21. The interface of claim 18, wherein step (a) further comprises the step of:
(f) reducing the translated regular sub-query Eₚ by evaluating one or more qualifiers in the sub-query p to one or more respective truth values.

22. The interface of claim 18, wherein step (a) further comprises the step of:
(g) combining two or more translated regular sub-queries to produce the regular query E_{Q}.

23. The interface of claim 16, wherein step (a) further comprises the steps of:
(h) identifying two or more sub-queries p of the input query Q; and
(i) topologically sorting the two or more sub-queries p.

24. The interface of claim 16, wherein step (b) is performed using a least fixpoint operator LFP.

25. The interface of claim 16, wherein step (b) comprises the steps of:
(j) computing, for a sub-expression e of the regular query E_{Q},a relational algebra query translation of the sub-expression e.

26. The interface of claim 25, wherein step (b) further comprises the step of:
(k) associating the relational algebra translation of the sub-expression e with a temporary table Rₑ; and
(l) incrementing a list Q′ with an element from the temporary table Rₑ).

27. The interface of claim 16, wherein step (b) further comprises the step of:
(m) repeating steps (j), (k) and (l) for each sub-expression e of the regular query E_{Q} until the list Q′ is equivalent to the regular query E_{Q}.

28. The interface of claim 16, wherein step (b) further comprises the steps of:
(n) identifying two or more sub-expressions of the regular query E_{Q}; and
(o) topologically sorting the two or more sub-expressions.

29. The interface of claim 16, wherein the processor is further configured to perform the step of:
(p) reducing the regular query E_{Q} by one or more of (i) eliminating empty sets e and (ii) extracting common sub-queries.

30. The interface of claim 16, wherein wherein the input query Q and the regular query E_{Q} are written in the XPATH language.
